(19) United States
(12) Patent Application Publication
(10) Pub. No.: US 2015/0354827 A1
(43) Pub. Date: Dec. 10, 2015

(54) STEAM COOKING METHOD AND STEAM COOKING OVEN

(71) Applicant: ELECTROLUX HOME PRODUCTS CORPORATION N.V., Brussels (BE)

(72) Inventors: Paolo FARALDI, Forli (IT); Riccardo FURLANETTO, Pordenone (IT); Evi HESSENAUER, Forli (IT); Arianna BOZZATO, Pordenone (IT); Richard TUREK, Rothenburg ob der Tauber (DE)

(73) Assignee: Electrolux Home Products Corporation N.V., Brussels (BE)

(21) Appl. No.: 14/439,415

(22) PCT Filed: Jan. 10, 2014
(86) PCT No.: PCT/EP2014/050390

§ 371 Date: Apr. 29, 2015

(30) Foreign Application Priority Data
Jan. 11, 2013 (EP) 13150995.2

(51) Int. Cl. F24C 7/08; F24C 15/00; A47J 27/62; A23L 1/01

(52) U.S. Cl. CPC F24C 7/088; A23L 1/0121; F24C 15/003; A47J 27/62

(57) ABSTRACT

Method for operating a steam cooking oven including placing vacuum packed food in an oven cavity and heating the cavity until the oven cavity centre has reached a defined temperature by supplying steam generated by a steam generator into the cavity, wherein a convection fan is operated within the cavity. The cavity is maintained at the defined temperature by supplying steam into the cavity over a certain period of time while the defined temperature of the centre is not allowed to vary about more than +/−1.5° C. During the heating step and the maintaining step the actual temperature of the centre is determined by a control unit using an algorithm that is based on the temperature values measured by a temperature sensor within the cavity, wherein the actual temperature is used to operate the steam generator such that the defined temperature of the centre is reached or maintained.

The present invention relates to a steam cooking method and a steam cooking oven.

Sous Vide cooking is a well established technique for professional cooks, that is growing in popularity and application also for the private households. Sous vide is French for “under vacuum” and describes a method of cooking in vacuum sealed plastic pouches at low temperatures for long times. Vacuum can be described more precisely as low pressure with some remaining air or gaseous atmosphere having a lower pressure than the normal atmospheric pressure. With the proper equipment and some basic knowledge, anyone can prepare consistently delicious and safe food.

Vacuum packaging prevents evaporative losses of flavor volatiles and moisture during cooking and inhibits off-flavors from oxidation: This results in especially flavorful and nutritious food. Vacuum sealing also reduces aerobic bacterial growth and allows for the efficient transfer of thermal energy from the water or steam to the food.

Sous vide typically consists of three stages: preparing for packaging, cooking and finishing. In almost all cases, the cooking medium is either a water bath or a convection steam oven. Standard household steam ovens do not heat uniformly enough to apply Sous Vide technique.

The document EP 2 363 048 B1 describes a steam oven for cooking food placed in a vacuumized and sealed pouch and comprising a user interface and an electronic control unit, wherein said steam oven carries out a defined heating process on the basis of a food category and a predetermined reduction of food pathogens.

However, this document does not disclose the design of a steam oven that is able to provide steam cooking conditions that are sufficient for reliable, repeatable and safe sous vide cooking. Further, it is not described which heating means or which operation of heating means has to be used to achieve such a defined heating process.

The use of steam cooking ovens is preferable over water baths, due to energy saving effects and a larger operating volume.

It is an object of the present invention to provide a steam cooking oven that enables reliable and repeatable sous vide cooking as well as safe sous vide cooking conditions.

It is a further object of the present invention to provide a steam cooking method for sous vide cooking by means of which a steam cooking oven can be operated such that reliable and repeatable sous vide cooking conditions are produced, wherein at the same time the steam cooking method makes the use of sous vide cooking more simple for the user.

The above objects of the invention are achieved by a steam cooking method according to claim 1 and a steam cooking oven according to claim 5.

A steam cooking method for operating a steam cooking oven according to claim 1 comprises at least the following steps:
placing vacuum packed food stuff in an oven cavity;
a heating step comprising heating up the oven cavity until the oven cavity centre has reached a defined temperature by operating a steam generator and supplying steam generated by the steam generator into said oven cavity, wherein a convection fan is operated within the oven cavity;
a maintaining step comprising maintaining said oven cavity at said defined temperature of the oven cavity centre by operating said steam generator and supplying steam generated by the steam generator into said oven cavity over a certain period of time while said defined temperature of the oven cavity centre is not allowed to vary about more than +/−1.5° C.;
wherein at least during said heating step and said maintaining step the actual temperature of the oven cavity centre is determined by a control unit of the steam cooking oven by means of an algorithm that is based on the temperature values measured by a temperature sensor within the oven cavity and wherein said actual temperature is used to operate the steam generator such, that said defined temperature of the oven cavity centre is reached or maintained.

Such a method enables to heat up the oven cavity centre to a defined temperature, wherein a temperature overshot for more than 2° C. over the target temperature does not occur. For this purpose the operation of the steam generator is stopped or reduced early enough depending on the detected temperature of the oven cavity centre. It is further advantageously possible to maintain a convection regime in a defined region of the oven cavity with respect to the temperature in the oven centre within an acceptable temperature range.

In an advantageous embodiment of the inventive method said exhausting step is provided for exhausting the steam from inside of the oven cavity, in particular such that said exhausting step comprises that heating elements different from the steam generator are operated to deliver a defined amount of heat to said oven cavity, such that the oven cavity air or a mixture of oven cavity air and steam being in the oven cavity expand within said oven cavity, in particular such that exhausting of the steam from inside of the oven cavity is promoted.

Thus, an increased exhaust flow of steam can be produced which quickens the reduction of saturation within the oven cavity. This results in a quickly reduced heat transfer to the food stuff due to less condensation on the food stuff. Therefore, a slow stop of the cooking process is reached, reducing the risk of overcooking and temperature overshot in the food stuff.

In a further advantageous embodiment of the invention, the inventive method is carried out such, that
an exhaust outlet provides a passage for exhausting steam, that is closed or reduced to a substantially small, in particular to the minimum possible, passage during said heating step;
said exhaust outlet provides said passage for exhausting steam closed or reduced to a substantially small, in particular to the minimum possible, passage during said maintaining step;
said exhaust outlet provides said passage for exhausting steam fully opened or substantially wide, in particular as the maximum possible passage;
in particular that said exhaust outlet is operated by means of a control unit of said steam cooking oven;

Thus, the steam exhaust during the heating step and the maintaining step is reduced and the saturation in the oven cavity can be quickened, upon need. Further, during the exhaust step, the desteaming can also be quickened, leading to a quick reduction of saturation, also when needed.

In a further embodiment of the invention said exhausting step is carried out not longer than 3 minutes and/or wherein said defined temperature of the oven cavity centre is not allowed to vary about more than +/−3° C. during said exhausting step.

This results in an advantageous slow and precise stop of the condensation on the food stuff, while the temperature of the oven cavity centre can be operated very precise. Thus, the cooking result is advantageously good.

The above described problems are also advantageously solved by a steam cooking oven according to claim 5.

Such a steam cooking oven, in particular for sous vide cooking processes, comprises:
an oven cavity for placing vacuum packed food stuff in defined positions therein;
at least one steam generator for supplying steam into said oven cavity;
at least one convection fan arranged at or inside of said oven cavity for generating a gas flow within said oven cavity, wherein said gas flow is generated so that said convection fan sucks oven cavity air or a mixture of oven cavity air and steam from at least one first direction and blows said oven cavity air or said mixture of oven cavity air and steam in one or more second directions different from said first direction;
wherein:
said steam supplied from said steam generator and said gas flow generate a defined flow pattern inside of said oven cavity at least in the defined positions where said food stuff can be placed;
wherein said steam supplied from said steam generator is continuously stirred into said gas flow, in such way that said flow pattern creates a homogenous convection regime around said food stuff;

Thus, a steam cooking oven is provided in which the food stuff is evenly heated by condensation of steam or vapour, respectively, wherein no additional heating, e.g. by resistive heating elements is required. A uniform and even convection regime is created around the food stuff to be cooked ensuring the correct desired cooking result. A homogenous convection regime shall be understood as a continuous and homogeneous forced convection flow avoiding or limiting a flow directly hitting the food stuff. A continuous convection regime around the vacuumed food stuff avoids local depletions of air humidity, due to possible calm air zones, efficiently providing steam saturation around the pouch of the food stuff all over the cooking process.

In an advantageous embodiment of the invention, said steam generator supplies said steam to the oven cavity via an outlet. In a further advantageous embodiment of the invention said steam generator is adapted to the oven cavity such, that the ratio of generator power to cavity volume is equal or more than 16 Watt/litre. In a further advantageous embodiment of the invention said steam generator enables said steam cooking oven to reach approximately 100% humidity within said oven cavity at a temperature below 100° C. within 250 s or faster.

A steam generator of this size enables a fast supply of steam into the oven cavity. Thus, enough steam can be released into the oven cavity to guarantee, that the food is mainly heated up by steam or vapour condensation. Further, the steam generation is, thus, quick enough to reach a temperature set point and saturation of 100% humidity in the oven cavity in a very short time. The temperature increase of the food stuff begins most advantageously as soon as saturation is reached. E.g. it is advantageous, if 100% humidity is reached within 250 s for a temperature set point of 96° C. and is substantially kept over the complete cooking cycle. Such condition can be achieved by means of the inventive embodiment. Further, a steam outlet within the oven cavity is advantageously carefully controlled. Due to the quick heating rate, hot spots, e.g. steam jets, which lead to inhomogeneous temperature fields in the food and potentially damage the pouches could occur. However, this is prevented by means of the above defined flow pattern in combination with a such dimensioned and designed steam generator and outlet.

In a further advantageous embodiment of the invention, said steam generator is arranged inside of the oven cavity, being in particular a bowl-shaped steam generator, and comprises a large-surface outlet.

A bowl-shaped steam generator has the advantage, that it can have a slow speed outlet, e.g. formed by a wide boiling water surface. Thus, a slow steam speed of the steam supplied to the oven cavity can be achieved which does not disturb the convection regime within the oven cavity.

In an alternative advantageous embodiment said steam generator is arranged outside of the oven cavity, being in particular a flow-type steam generator, wherein said outlet is a nozzle, in particular said outlet comprises a diffuser element.

Also with a nozzle, and in particular with a diffuser element, a slow speed outlet can be achieved. A nozzle of a flow-type steam generator has the further advantage, that it can be arranged in the oven cavity or on the cavity walls were it is most favourable for stirring steam into the gas flow.

In a further advantageous embodiment of the invention, said convection fan is operated such, that said gas flow is a laminar gas flow at least in the region where said gas flow passes said outlet, in particular continuously stirring the steam into the gas flow.

By means of a laminar gas flow passing the outlet, the absorption or collection of the steam into the gas flow is very effective. In combination with a bowl-shaped generator a laminar gas flow can be even more effective.

In a further advantageous embodiment of the invention, said convection fan is operated such, that said gas flow is a turbulent gas flow at least in the region where said gas flow passes said outlet, in particular continuously stirring the steam into the gas flow.

E.g. in combination with a nozzle a turbulent gas flow might be very effective to absorb or collect the steam into the gas flow. It is possible, that the convection fan can be operated such, that a laminar gas flow and a turbulent gas flow are generated, e.g. alternately.

In a further advantageous embodiment of the invention, said convection fan is arranged adjacent to a rear wall of said oven cavity, wherein a fan shield is arranged between the convection fan and the oven cavity, wherein said arrangement of the convection fan and the fan shield guides said gas flow past the outlet of said steam generator.

Thus, the supplied steam can be immediately stirred to the gas flow contributing to an ideal steam distribution. Variations in the gas flow can be minimized in such way.

According to a further advantageous embodiment of the invention, one or more heating elements are provided which can be operated such, that the heat supplied by said heating elements is less than 10% of the overall heat supplied to the oven cavity.

It has to be understood, that the heating elements can be all heating elements of the steam cooking oven different from the heating element of the steam generator. Thus, additional heat can be delivered to the oven cavity for regulating the temperature of the oven cavity centre without negatively affecting the even distribution of the steam in the oven cavity and the gas flow. Therefore, it is enabled to slightly operate the oven cavity temperature and in particular the oven cavity centre temperature.

According to a further advantageous embodiment of the invention at least one temperature sensor is provided in the oven cavity, and/or said steam cooking oven comprises a control unit which is adapted to carry out at least one algorithm by means of which the temperature in a central region of the oven cavity can be determined on the basis of the value measured by said temperature sensor, in particular wherein said control unit can control at least said steam generator and said convection fan.

Thus, the convection regime around the food stuff in the oven cavity centre can be controlled, operated and regulated in a very precise way. It is particularly advantageous to be able to determine the temperature of the oven cavity centre indirectly by means of an algorithm based on a temperature sensor which is, e.g. arranged on a cavity wall, because in such case it is not necessary to arrange a sensor in the cavity centre itself.

In a preferred advantageous embodiment of the invention a temperature probe is provided which is guided through a packaging of said food stuff and which is in direct contact to said food stuff, said temperature probe measuring the temperature of said food stuff.

Thus, an additional measurement, e.g. of the core temperature of the food stuff, is provided which improves the control and regulation of the temperature of the oven cavity or of the oven cavity centre temperature.

In a further advantageous embodiment of the invention said oven cavity comprises at least one exhaust outlet having a variable exhaust passage, in particular wherein the exhaust passage can be reduced to at least 50% of its maximum passage, said exhaust outlet preferably being controlled by said control unit.

Thus, a reduced outflow of steam out of the oven cavity can be provided and the heating up of the cavity by steam saturation can be quickened. Further, such a variable exhaust outlet enables the steam cooking oven to run conventional cooking modes, such as hot air modes or conventional convection cooking modes.

All described embodiments of the invention have the advantage, that sous vide cooking can be carried out manually or by using pre-set recipes. Manual setting and recipes can be provided in a memory unit connected or part of the control unit.

The present invention will be described in further detail with reference to the drawings, in which

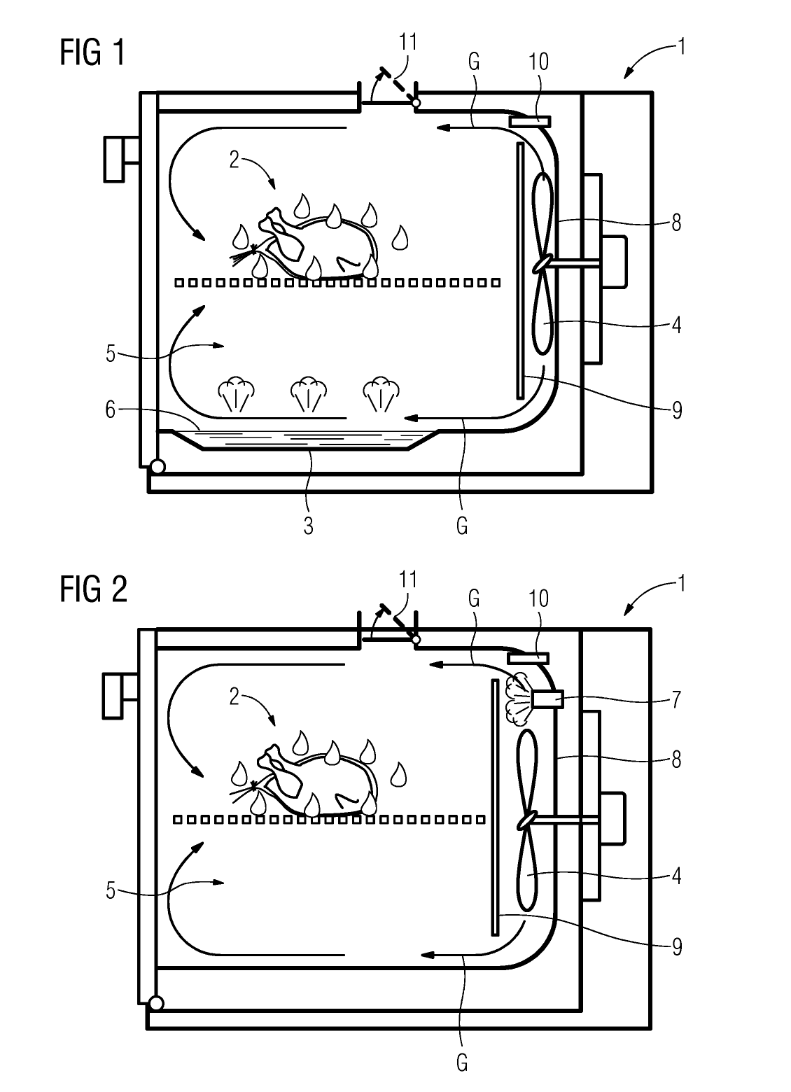

FIG. 1 illustrates a side sectional view of a steam cooking oven showing a first inventive embodiment;

FIG. 2 illustrates a side sectional view of a steam cooking oven showing a second inventive embodiment;

FIG. 1 shows a steam cooking oven 1 comprising an oven cavity 5 which is closed by a front door. Food stuff 2 which is packed in a plastic pouch, is placed in a central region of the oven cavity 5. Usually oven cavities comprise means for positioning food stuff in different defined vertical positions, such as guiding rails or lateral embosses.

The oven cavity 5 comprises several cavity walls such as a rear wall 8. A convection fan 4 is arranged adjacent to the rear wall 8 in the oven cavity 5 and is covered by a fan shield 9 that guides a gas flow G generated by the convection fan 4 in defined directions.

A bowl-shaped liquid container of the steam generator 3 is formed to a bottom wall of the oven cavity 5. The liquid container of the steam generator 3 can be filled with a liquid, e.g. water, which can be evaporated by means of a heating element provided by the steam generator 3. An outlet 6 is formed by the liquid container which allows the evaporated steam to reach a central region of the oven cavity 5.

The gas flow G generated by the convection fan 4 is guided by the fan shield 9 such, that it passes the outlet 6 of the steam generator 3. The convection fan is of a centrifugal type, wherein the fan intake arranged in the fan shield 9 is placed substantially at mid height of the rear wall 8. The convection fan position and fan shield design and position and the resulting flow pattern shall be positioned with respect to the outlet 6, 7 of the steam generators so that ingoing steam is immediately intercepted and stirred or mixed to the air.

The convection fan 4 can be controlled and operated such, that a fan operation is ensured over the complete cooking cycle with a fan speed sufficient to allow a most effective mixing of steam into the gas flow G. The fan rotation speed or the rotation direction can be varied to further improve steam stirring and even distribution.

The gas flow 6 that passes by the outlet 6 absorbs or collects steam which leaving the steam generator 3. In this way, the steam is stirred to the gas flow G without disturbing the even distribution of the previously supplied steam in the oven cavity 5.

A large surface of the outlet 6 is created which allows a relatively large amount of steam to enter the oven cavity with a relatively slow flow speed. Thus, the convective conditions, i.e. the convection regime, in the central region of the oven cavity 5 are not disturbed by the steam supply and it is possible to maintain a stable homogenous convection in the central region of the oven cavity 5.

FIG. 2 shows a steam cooking oven 1 like in FIG. 1. However, the steam cooking oven 1 comprises no bowl-shaped steam generator, but a flow-type steam generator (not shown) that is arranged outside of the oven cavity 5. The flow-type steam generator is connected with the oven cavity 5 via an outlet 7 that comprises a nozzle with a diffusion element. By means of the diffusion element, the steam let out of the outlet 7 is evenly distributed over a relatively wide volume and can be absorbed or collected by the gas flow G passing by.

A temperature sensor 10 is provided in both embodiments in an upper rear region of the oven cavity 5 to monitor the oven cavity temperature. An algorithm is provided to evaluate the temperature of the oven cavity centre on the basis of the temperature detected by the temperature sensor 10. The oven cavity centre temperature is controlled on the basis of the information given from the temperature sensor 10 to a control unit.

Advantageously, a food probe, e.g. a needle temperature probe, can be inserted into the food stuff through the pouch and can be provided to determine the temperature of the food stuff directly. To prevent gas or liquid from entering the punctured bag, the food probe can be inserted through, e.g. closed cell foam tape, capable to self repair the punctured pouch.

A variable section exhaust, exhaust section reduction at least 50%, named exhaust outlet 11, is provided to ensure a reduced outflow from the oven cavity 5 and speed up cavity steam saturation when needed. This feature allows the oven to run conventional cooking modes, along with Sous Vide cooking cycles. An electronic control system, capable to execute a closed loop temperature control, acquiring the signal from the temperature sensor 10 and from the needle probe, if provided, and controlling the steam generator 3, the heating elements, the variable section exhaust outlet 11, to execute a multi-phase cooking cycle, changing behaviour for each cycle according to set parameters.

To execute a sous Vide cooking technique, an oven control needs to run a cycle being composed at least by the following three phases:

Heating:

The electronic control set the exhaust section of the exhaust outlet 11 to the minimum value, activates the cooking fan, i.e. convection fan 4, and switches on the steam generator 3 to maximum power. Also, some support to the heating process can be achieved by partial activation of other heating elements (less than 10% of overall heat supply). Temperature target shall be reached with no or minimum overshoot (<2° C.) for oven centre temperature: to achieve this target, as previously mentioned, the position of the cavity temperature sensor 10 must be chosen according to the steam generator position to avoid direct steam flow on the sensor and to fan position to avoid excess of convection heat transfer on the sensor. An evaluation algorithm must be the applied, to estimate temperature in oven center cavity with high precision.

Maintenance:

The electronic control keeps set the exhaust section to the minimum value, the cooking fan activated, and controls the heat input in the cavity (hence to the food) by controlling the activation of the steam generator (by a time based variable duty cycle or by modulating the power output). The maximum ripple of oven center temperature shall be within +/−1.5 ° C. around the set point, with an offset between the average observed temperature and the set point <1° C. This variation is effectively averaged by the insulation effect given by the plastic bag, resulting in a variation in the food reduced enough to guarantee excellent results.

Desteaming:

The electronic control opens the exhaust section of the exhaust outlet 11 to the maximum value, keeps the cooking convection fan 4 activated, and delivers a minimum amount of heat by resistive heating elements: this results in a slight expansion of air in the oven cavity 5. This results in an increased exhaust flow that promotes steam excess evacuation. Prompt reduction of cavity saturation results also in a reduced heat transfer to food, due to less condensation happening on food: this is important to actually slow down cooking process, reducing the risk of overcooking and temperature overshot in the food. This phase duration must be <3 minutes and the maximum ripple in oven centre temperature control during this phase shall not exceed +/−3 ° C.

Under the point of view of cycle setup to fit different foodstuff, the two parameters to set are:
Time (cycle duration)
Temperature (oven center temperature during maintenance phase)

The user has the chance to drive the Sous Vide cooking mode either manually or using pre-set recipes.

Manual Setting

a Sous Vide cooking function is provided in the navigation tree; the user selects such function and it is asked to input time and temperature to launch the cooking process.

Pre-Set Recipes:

for a set of predefined recipes (preparation, ingredients type and quantity, etc.) time and temperature setting are pre-set; the user can browse these recipes in the user interface navigation tree, and, by selecting one of these, starts the Sous Vide cooking function with pre-set time and temperature for chosen recipe.

### LIST OF REFERENCE NUMERALS

1 steam cooking oven
2 food stuff
3 steam generator
4 convection fan
5 oven cavity
6 outlet
7 outlet
8 rear wall
9 fan shield
10 temperature sensor
11 exhaust outlet
G gas flow
T_{d} defined temperature of oven cavity centre
Tₐ actual temperature of oven cavity centre
R ratio=generator power/cavity volume

1. Steam cooking method for operating a steam cooking oven (1) comprising at least the following steps:
placing vacuum packed food stuff (2) in an oven cavity (5);
a heating step comprising heating up the oven cavity (5) until the oven cavity centre has reached a defined temperature (T_{d}) by operating a steam generator (3) and supplying steam generated by the steam generator (3) into said oven cavity (5), wherein a convection fan (4) is operated within the oven cavity (5);
a maintaining step comprising maintaining said oven cavity (5) at said defined temperature (T_{d}) of the oven cavity centre by operating said steam generator (3) and supplying steam generated by the steam generator (3) into said oven cavity (5) over a certain period of time while said defined temperature (T_{d}) of the oven cavity centre is not allowed to vary about more than +/−1.5° C.;
wherein at least during said heating step and said maintaining step the actual temperature (Tₐ) of the oven cavity centre is determined by a control unit of the steam cooking oven (2) by means of an algorithm that is based on the temperature values measured by a temperature sensor within the oven cavity (5) and wherein said actual temperature (Tₐ) is used to operate the steam generator such, that said defined temperature ((T_{d}) of the oven cavity centre is reached or maintained.

2. Steam cooking method according to claim 1, characterized in that said an exhausting step is provided for exhausting the steam from inside of the oven cavity, in particular such that said exhausting step comprises that heating elements different from the steam generator are operated to deliver a defined amount of heat to said oven cavity (5), such that the oven cavity air or a mixture of oven cavity air and steam being in the oven cavity (5) expand within said oven cavity (5), in particular such that exhausting of the steam from inside of the oven cavity is promoted.

3. Steam cooking method according to claim 1, characterized in that
an exhaust outlet provides a passage for exhausting steam, that is closed or reduced to a substantially small, in particular to the minimum possible, passage during said heating step;
said exhaust outlet provides said passage for exhausting steam closed or reduced to a substantially small, in particular to the minimum possible, passage during said maintaining step;
said exhaust outlet provides said passage for exhausting steam fully opened or substantially wide, in particular as the maximum possible passage;
in particular that said exhaust outlet is operated by means of a control unit of said steam cooking oven;

4. Steam cooking method according to claim 1, characterized in that said exhausting step is carried out not longer than 3 minutes and/or wherein said defined temperature (Td) of the oven cavity centre is not allowed to vary about more than +/−3° C. during said exhausting step.

5. Steam cooking oven (1), in particular for sous vide cooking processes, comprising:
an oven cavity (5) for placing vacuum packed food stuff (2) in defined positions therein;
at least one steam generator (3) for supplying steam into said oven cavity (5);
at least one convection fan (4) arranged at or inside of said oven cavity (5) for generating a gas flow (G) within said oven cavity (5), wherein said gas flow (G) is generated so that said convection fan (4) sucks oven cavity air or a mixture of oven cavity air and steam from at least one first direction and blows said oven cavity air or said mixture of oven cavity air and steam in one or more second directions different from said first direction;
wherein:
said steam supplied from said steam generator (3) and said gas flow (G) generate a defined flow pattern inside of said oven cavity (5) at least in the defined positions where said food stuff (2) can be placed;
wherein said steam supplied from said steam generator (3) is continuously stirred into said gas flow (G), in such way that said flow pattern creates a homogenous convection regime around said food stuff (2);

6. Steam cooking oven (1) according to claim 5, characterized in that said steam generator supplies said steam to the oven cavity (5) via an outlet (6, 7) and/or in that said steam generator (3) is adapted to the oven cavity (5) such, that the ratio (R) is equal or more than 16 Watt/litre, wherein ratio (R)=generator power/cavity volume and/or in that said steam generator (3) enables said steam cooking oven (1) to reach approximately 100% humidity within said oven cavity (5) at a temperature below 100° C. within 250 s or faster.

7. Steam cooking oven (1) according to claim 5, characterized in that said steam generator (3) is arranged inside of the oven cavity (5), being in particular a bowl-shaped steam generator, and comprises a large-surface outlet (6).

8. Steam cooking oven (1) according to claim 5, characterized in that said steam generator (3) is arranged outside of the oven cavity (5), being in particular a flow-type steam generator, wherein said outlet (7) is a nozzle, in particular said outlet (7) comprises a diffuser element.

9. Steam cooking oven (1) according to claim 5, characterized in that said convection fan (4) is operated such, that said gas flow (G) is a laminar gas flow at least in the region where said gas flow (G) passes said outlet (6, 7), in particular continuously stirring the steam into the gas flow (G).

10. Steam cooking oven (1) according to claim 5, characterized in that said convection fan (4) is operated such, that said gas flow (G) is a turbulent gas flow at least in the region where said gas flow (G) passes said outlet (6, 7), in particular continuously stirring the steam into the gas flow (G).

11. Steam cooking oven (1) according to claim 5, characterized in that said convection fan (4) is arranged adjacent to a rear wall (8) of said oven cavity (5), wherein a fan shield (9) is arranged between the convection fan (4) and the oven cavity (5), wherein said arrangement of the convection fan (4) and the fan shield (9) guides said gas flow (G) past the outlet (6, 7) of said steam generator (3).

12. Steam cooking oven (1) according to claim 5, characterized in that one or more heating elements are provided which can be operated such, that the heat supplied by said heating elements is less than 10% of the overall heat supplied to the oven cavity (5).

13. Steam cooking oven (1) according to claim 5, characterized in that at least one temperature sensor (10) is provided in the oven cavity (5), and/or said steam cooking oven (1) comprises a control unit which is adapted to carry out at least one algorithm by means of which the temperature in a central region of the oven cavity can be determined on the basis of the value measured by said temperature sensor (10), in particular wherein said control unit can control at least said steam generator (3) and said convection fan (4).

14. Steam cooking oven (1) according to claim 5, characterized in that a temperature probe is provided which is guided through a packaging of said food stuff (2) and which is in direct contact to said food stuff (2), said temperature probe measuring the temperature of said food stuff (2).

15. Steam cooking oven (1) according to claim 5, characterized in that said oven cavity (5) comprises at least one exhaust outlet having a variable exhaust passage, in particular wherein the exhaust passage can be reduced to at least 50% of its maximum passage, said exhaust outlet preferably being controlled by said control unit.
